(19) United States
(12) Patent Application Publication
(10) Pub. No.: US 2008/0256464 A1
(43) Pub. Date: Oct. 16, 2008

(54) SYSTEM AND METHOD OF USER INTERFACE BASED BAND HAVING CONTEXTUAL OBJECT

(76) Inventors: Aurobinda Pradhan, Bangalore (IN); Sachin Vinod Rathi, Nagpur (IN)

Correspondence Address: SAP AG, 3410 HILLVIEW AVENUE, PALO ALTO, CA, 94304, US

(21) Appl. No.: 11/734,270

(22) Filed: Apr. 11, 2007

(51) Int. Cl. G06F 3/00; G06F 17/30

(52) U.S. Cl. 715/762; 707/3; 707/E17.014

(57) ABSTRACT

Embodiments of the invention are generally directed to a system and method to provide contextual object attributes in a browser window user interface at runtime. The objects are context sensitive and displayed in a band of the browser. Each object is associated with different services for supporting changes during runtime. After invoking a band in the browser, a search for a contextual object attribute provides a list of context object attributes related to the searched object. On selecting the relevant object, the object can then be displayed. Configuring the contextual objects is based on defined metadata for the business object, the domain model and the business application. The selected object can be displayed in a band of the window during runtime.

### FIELD OF THE INVENTION

Embodiments of the invention generally relate to the field of graphical user interfaces (GUI), more particularly to the field of web-based graphical user interfaces that can enhance the user experience by providing contextual information.

### BACKGROUND OF THE INVENTION

A user interface provides access and control to an automated system. More particularity in a computer system, a graphical user interfaces (UI) accepts input via devices such as computer keyboard and a pointing device used to provide articulated graphical output on a computer monitor.

In a typical computer system, a UI provides interactivity and control to the software. The application can be any program that provides business functionality, for example, a business application for tracking the status of a parcel or a package. In those cases where applications are delivered over the Internet they are commonly referred to as Web applications. Business applications on the network depend upon server side functionalities and rich clients to provide user experience. In the conventional web applications, a client application is typically closed coupled to its respective server application. For example, Yahoo® Toolbar and Google® Toolbar are attachable client application components to an existing browser and each toolbar is coupled to its respective server. Thus, the provided interactivity is limited.

As an example of a conventional web application, a browser is used to track the status of a parcel send using Fedex®. A user can obtain the status by visiting the vendor's Fedex website and providing the parcel's “tracking id” for status. The problem is that when the user sees or finds this number “tracking id” in an email or browser page, he needs to specially go to vendor's website and he cannot obtain the status using a single selection step. To obtain the current status one will have to visit the vendor's website and enter “tracking id” in the provided field to query the system for the status. Some web applications have attempted to provide this “tracking id” as a hyperlink, with the existing hyperlink taking the user to the webpage with the tracking information. However this conventional web application does not provide other relevant information such as the service providers phone number, expected time of delivery and other such related information. What is needed is a useful way to display the relevant information directly to the user rather than requiring an individual or special search.

Another limitation with conventional browsers is that they have poor features for the end user as the design is rigid and the browser cannot be dynamically changed based on runtime requirements. This means that the GUI is designed only at design time and not at runtime. Also, providing contextual information is a challenge because the browser does not support such information. What is needed is a browser that supports internal and external contextual information. There is a further need for providing a high level of interactivity and user control to applications that would provide rich user experience. There is a further need to provide such contextual information in web applications at runtime.

The non-availability of the runtime contextual information in a web application is a serious problem for users. What is needed is a system and method for providing high level of interactivity and user control for an application UI. In addition, there is a further need for a system and method that can provide external and internal contextual information in relation to the UI content.

### SUMMARY OF THE INVENTION

Embodiments of the invention are generally directed to a system and method to provide contextual object attributes in a browser window user interface at runtime. The objects are context sensitive and displayed in a band of the browser. Each object is associated with different services for supporting changes during runtime. The browser supports internal contextual information sources such as private databases and external information sources such as public databases available via the Internet. After invoking a band in the browser, a search for a contextual object attribute provides a list of context object attributes related to the search target product. On selecting a relevant object, the object can then be displayed. Configuring the contextual object is based on defined metadata for the business object, the domain model and the business application. The selected object can be displayed in a band of the window during runtime.

### BRIEF DESCRIPTION OF THE DRAWINGS

Embodiments of the invention are illustrated by way of example, and not by way of limitation, in the figures of the accompanying drawings in which like reference numerals refer to similar elements.

FIG. 1 is a flow diagram illustrating an example method for providing a contextual object in a user interface band, according to an embodiment of the invention.

FIG. 2 is a flow diagram illustrating an example detailed method for providing a contextual object in a user interface band.

FIG. 3 is a system block diagram illustrating an example implementation for providing a contextual object in a user interface band

FIG. 4 is a screen display of an example graphical user interface illustrating a method for selecting and invocating a band in the browser window, according to an embodiment of the invention.

FIG. 5 is a screen display of an example graphical user interface illustrating a method for invocating a band in the browser window using browser toolbar, according to an embodiment of the invention.

FIG. 6 is a screen display of an example graphical user interface illustrating a quick access using a toolbar button for invocating a band in the browser window, according to an embodiment of the invention.

FIG. 7 is a screen display of an example graphical user interface illustrating a quick access using a dropdown list for invocating a band in the browser window, according to an embodiment of the invention.

FIG. 8 is a screen display of an example graphical user interface illustrating a quick access using an extension menu for invocating a band in the browser window, according to an embodiment of the invention.

FIG. 9 is a screen display of an example graphical user interface illustrating a search for an object in the browser window, according to an embodiment of the invention.

FIG. 10 is a screen display of an example graphical user interface illustrating a method for displaying bands in the browser window, according to an embodiment of the invention.

FIG. 11 is a screen display of an example graphical user interface illustrating a method for populating the band with the searched objects, according to an embodiment of the invention.

FIG. 12 is a screen display of an example graphical user interface illustrating a method for displaying the objects in a band of the browser window, according to an embodiment of the invention.

### DETAILED DESCRIPTION

Embodiments of the invention are generally directed to a system and method to provide contextual object attributes in a browser window user interface at runtime. The objects are context sensitive and displayed in a band of the browser. Each object is associated with different services for supporting changes during runtime. The browser supports internal contextual information sources such as private databases and external information sources such as public databases available via the Internet. After invoking a band in the browser, a search for a contextual object attribute provides a list of context object attributes related to the search target product. On selecting a relevant object, the object can then be displayed. Configuring the contextual object is based on defined metadata for the business object, the domain model and the business application. The selected object can be displayed in a band of the window at runtime.

One of the advantages of providing the contextual objects in a browser band is that the invention can be implemented as a client-side browser based band. The objects are user configurable and provide the context sensitive information. This band can be invoked by the invocation points such as a browser menu, a toolbar, a drop down menu, an extension menu, a shortcut, a personalization service and a quick access as illustrated below.

In an embodiment of the invention, once a band is invoked then the objects are added to it for later use. In an example for finding a DHL® parcel status, the invention provides the user with the current status of DHL parcel using the <tracking id> by using a single selection via a mouse on the tracking id number. This single selection via mouse will provide the user with contextual information based on the tracking id. Examples of contextual information includes the status, the expected time to delivery, the path taken, the recommendations about other competitive service provider, the customer care number in one's city and other such relevant information. In another embodiment of the invention, the context sensitive information such as alternative products, the search results, the quick access points and the emails can be provided by the UI. The user can add and save these kinds of object attributes in the band. The objects of the band are either pre-defined, user-defined or a collection of data. The user has the freedom to choose an object based on the required task. The band objects can be manipulated, added, rearranged, deleted and viewed. On recalling an object attribute from the band, the UI checks if the object attributes have changed since the last status and if so, then the UI updates the object attribute and saves the latest attribute in the band. This saved object attribute allows for the user to select and populate the band with the objects and its attributes at run-time. Another example of context sensitive object is if there is an address, the invention can suggest links to maps available for the addresses.

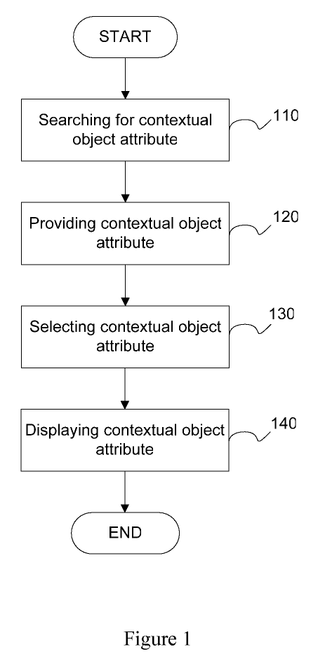

FIG. 1 is a flow diagram illustrating an example method for providing a contextual object in a user interface band, according to an embodiment of the invention. As illustrated in FIG. 1, the contextual object attribute is searched at 110. The UI provides for the contextual object attribute at 120 using the internal and the external contextual information sources. Examples of such an internal contextual information sources are private databases and examples of such an external information sources are public databases available via the Internet. The required contextual object attribute is selected at 130. The selected contextual object attribute is displayed at 140.

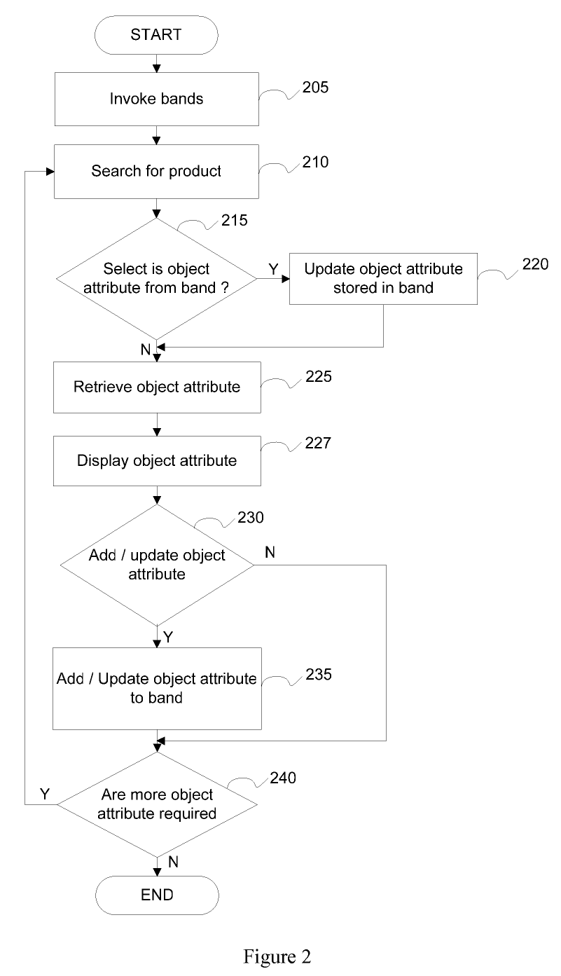

FIG. 2 is a flow diagram illustrating an example detailed method for providing the contextual object in a user interface band. The band objects are invoked in the browser band at 205. The invocation can be through several means such as a user click. For example, the user clicks on a product or invokes contextual menu if available and selects “Show competitor Product” or “Alternate Parts” or “Warehouse availability” or “Delivery Status” or “Product reviews”. The browser can have one or more bands. A search for a product at 210 obtains its contextual attributes called contextual object attribute. The user then selects the object attribute at 215, the object attribute may be available from an existing browser band or as a result of the search. If the object attribute is available from the band at 215, then the stored object attribute is updated in the band at 220. However, if the selected object is not from the band at 215 then it is retrieved from the search list at 225. The retrieved object attribute is displayed at 227. On recalling an object attribute from the band, the UI checks if the object attributes have changed or been updated at 230 since the last status, if yes then it updates the object attribute at 230. Thus allowing for user to select and populate the band with the object attributes at runtime. If no object attribute is added or updated to the band at 235 then the UI checks whether if more object attributes are required at 240. If more object attributes are required at 240, then the step at 210 of searching for the product onwards is repeated.

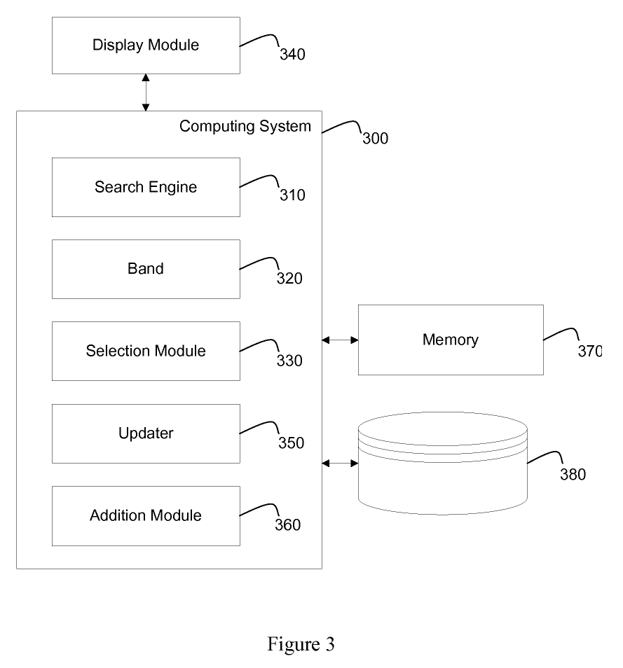

FIG. 3 is a system block diagram illustrating an example implementation for providing a contextual object in a user interface band. The processor of the computing system at 310 is electronically coupled to a memory at 370 and a display means at 340. The computing system at 300 includes a search engine at 310, a band at 320, a selection module at 330, an updator at 350 and an addition module at 360 and a data source at 380. The search engine at 310 searches for the contextual object attribute in the UI. The band at 320 provides for band in a browser window of the UI, where each band has one or more object attributes. The selection module at 330 provides a means for selecting the object attribute. The display module 340 provides a means for displaying the selected object attribute. If the object has changed since the last update, the updater at 350 is responsible for updating the object to the band. If the object has been added or deleted since the last update, the addition module at 360 is responsible for addition and deletion of the object from the band. The data source at 380 is coupled to the computing system 310 and supports both internal and external contextual information sources. Examples of such as internal contextual information sources are private databases and external information sources are public databases connected via the Internet.

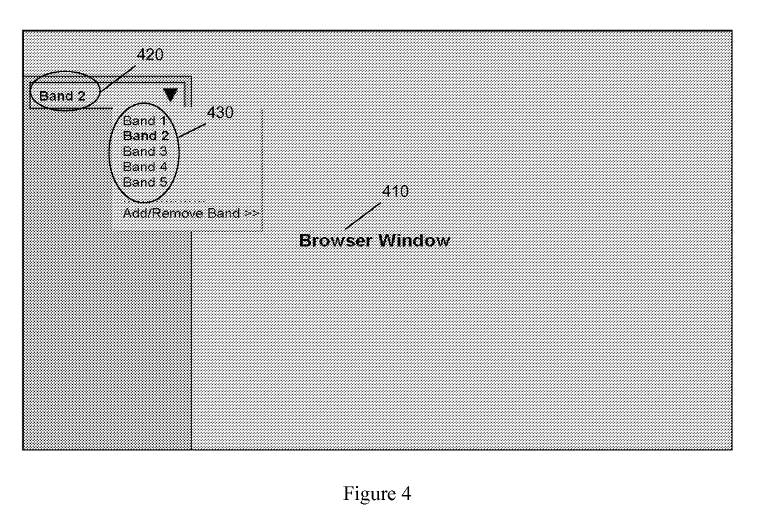

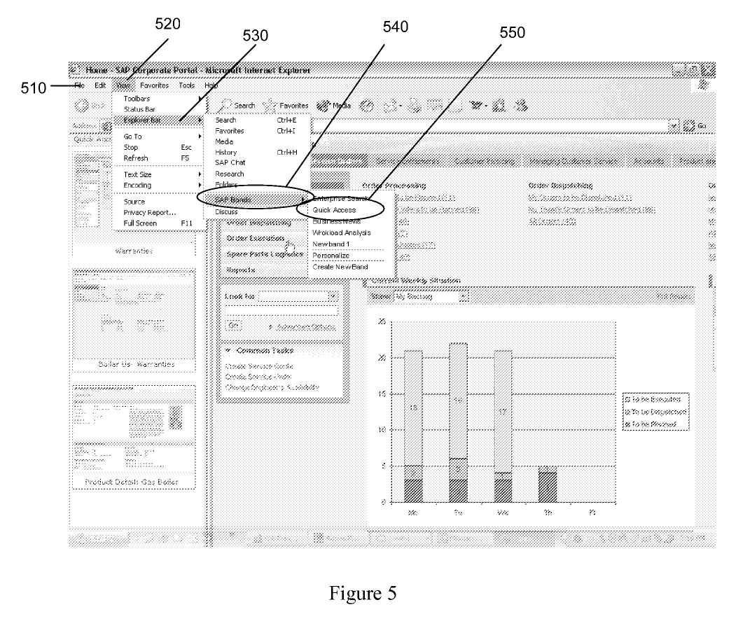

FIG. 4 through FIG. 8 illustrates several invocation methods of the object bands. FIG. 4 is a screen display of an example graphical user interface illustrating a method for selecting and invocating a band in the browser window, according to an embodiment of the invention. As illustrated in the figure, the user invokes the bands at 420 in the browser window at 410 using the quick access via the browser's toolbar button. The page is added to the quick access band as illustrated in FIG. 5 and the band is displayed. There can be more than one band at 430 and further these bands can be added or deleted. The browser band at 420 contains the object attributes.

FIG. 5 is a screen display of an example graphical user interface illustrating a method for invocating a band in the browser window using a browser toolbar, according to an embodiment of the invention. According to an embodiment of the invention, the user invokes the band via the browser “toolbar” at 510, under “view” at 520, then “explorer bar” at 530, then “SAP band” at 540 and then “Quick Access” at 550. Depending on the object attribute, the band is populated. Each band object is pre-configured based on the business application needs. The bands shows list or grid of objects added to it.

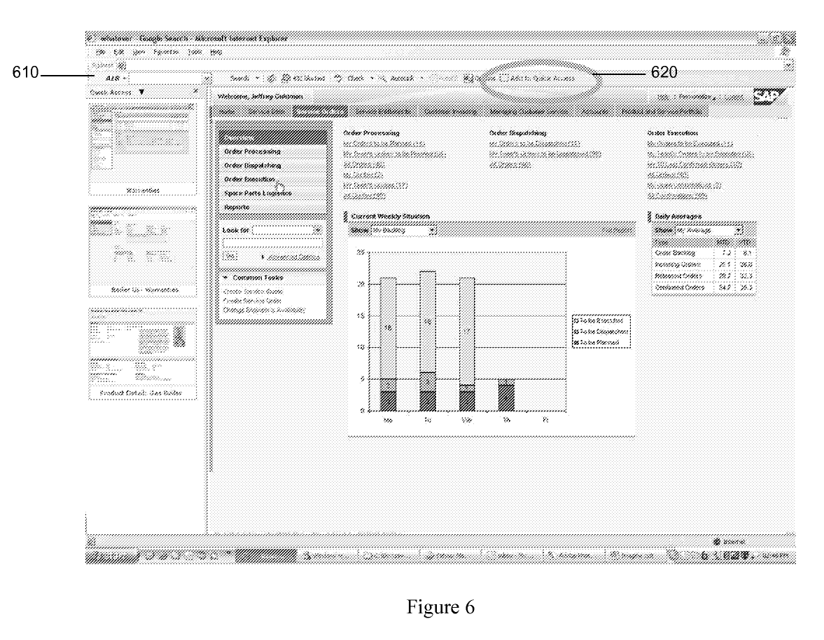

FIG. 6 is a screen display of an example graphical user interface illustrating a quick access using a toolbar button for invocating a band in the browser window, according to an embodiment of the invention. According to another embodiment of the invention, the band is invoked using a toolbar button at 610 such as “Add to Quick Access” at 620. The object is added to the quick access band and the band is displayed.

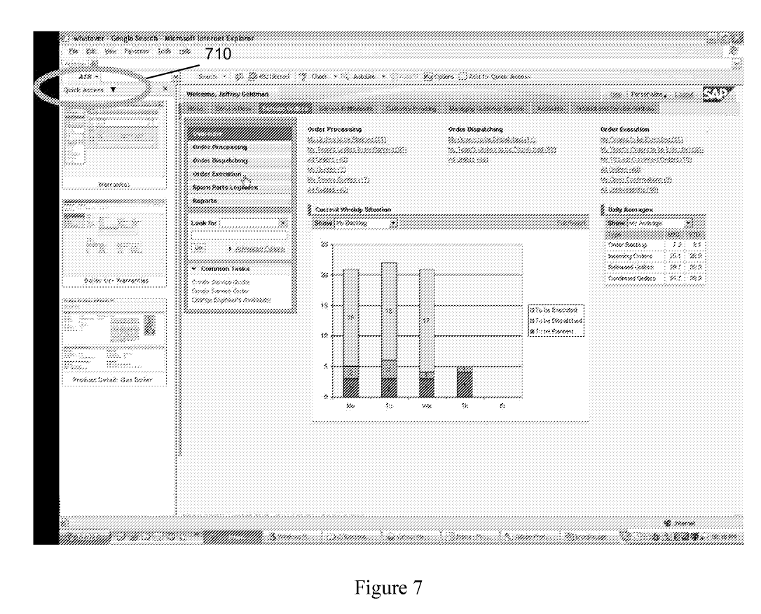

FIG. 7 is a screen display of an example graphical user interface illustrating a quick access button in the browser window for invocating a band using a dropdown list, according to yet another embodiment of the invention. According to an embodiment of the invention, the band is invoked using a dropdown list at 710 as illustrated.

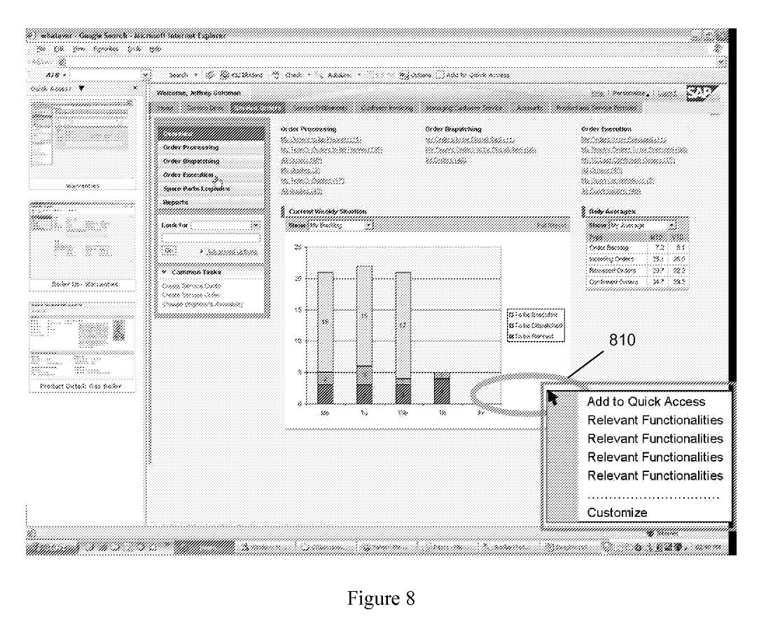

FIG. 8 is a screen display of an example graphical user interface illustrating a quick access using an extension menu for invocating a band in the browser window, according to an embodiment of the invention. According to an embodiment of the invention, the band is invoked using an extension menu at 810 as illustrated.

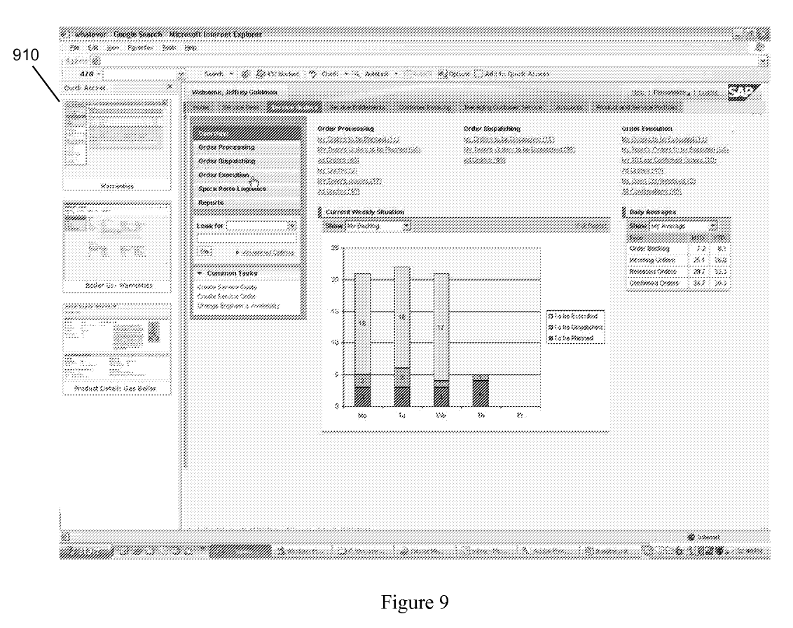

FIG. 9 is a screen display of an example graphical user interface illustrating a search for an object in the browser window, according to an embodiment of the invention. According to an embodiment of the invention, the search for an object at 910 obtains the result of the search.

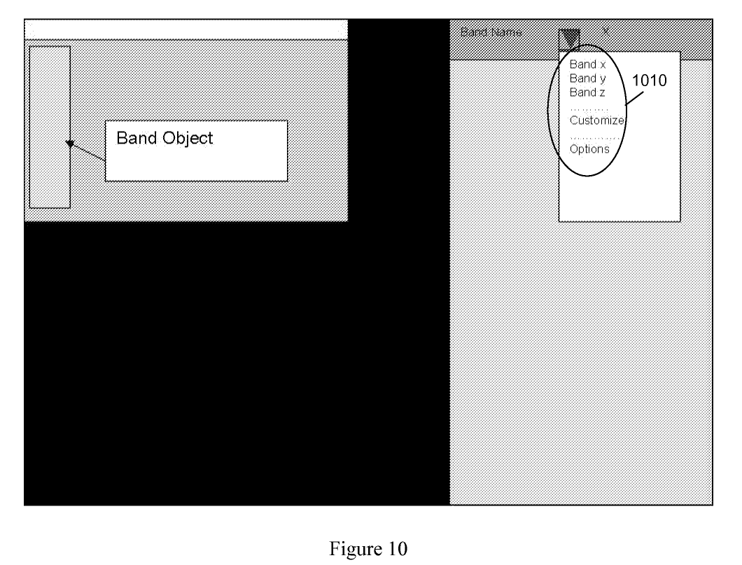

FIG. 10 is a screen display of an example graphical user interface illustrating a method for displaying bands in the browser window, according to an embodiment of the invention. According to another embodiment of the invention, the object addition or object updation at 1010 saves the objects and thus such storage leads to a personalization of that page.

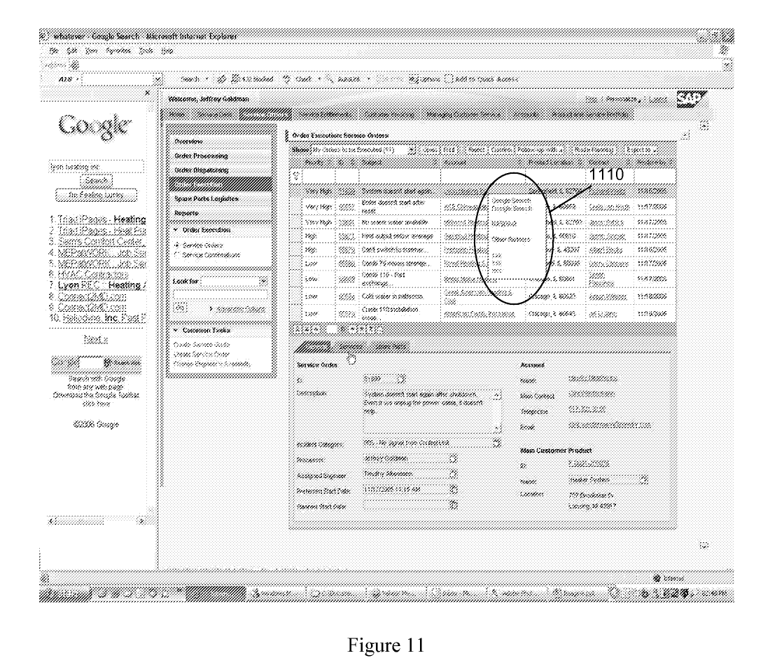

FIG. 11 is a screen display of an example graphical user interface illustrating a method for populating the band with the searched objects, according to an embodiment of the invention. According to an embodiment of the invention, the screen display illustrates a method for populating the bands at 1110. As illustrated in figure, the band is populated with business contacts. The example screen display illustrates a structure of last five business contacts and all other business contacts.

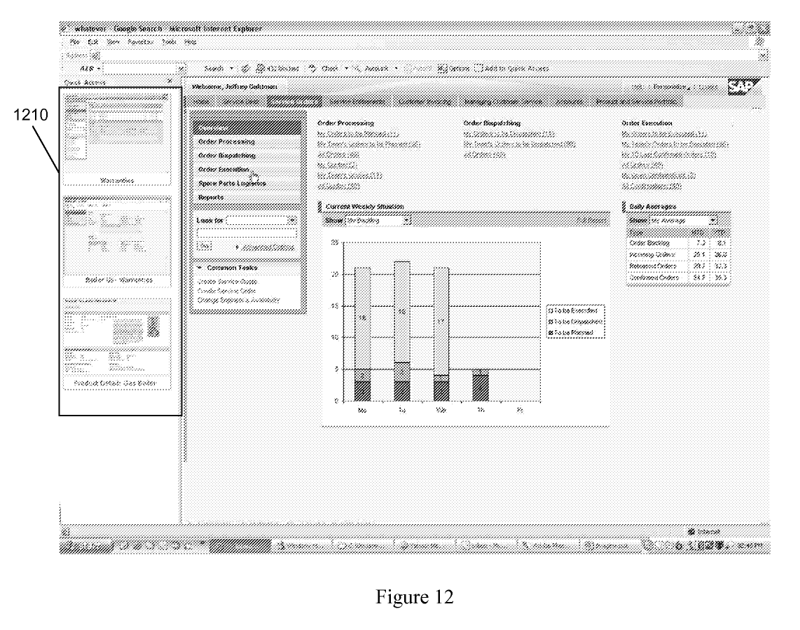

FIG. 12 is a screen display of an example graphical user interface illustrating a method for displaying the objects in a band of the browser window, according to an embodiment of the invention. According to an embodiment of the invention, the figure illustrates an example screen display for displaying of the objects at 1210. The displayed objects show the contextual bands without the content area and without band name.

What is claimed is:

1. A method, comprising:
searching for a contextual object attribute in a user interface;
providing the contextual object attribute in a band of the user interface;
selecting the contextual object attribute from the band to display; and
displaying the contextual object attribute in the user interface.

2. The method of claim 1, further comprises invoking the band for displaying the contextual object attribute.

3. The method of claim 2, wherein invoking the band comprises selecting an invocation point from a group consisting of a browser menu, a toolbar, a drop down menu, an extension menu, a shortcut, a personalization service and a quick access.

4. The method of claim 2, further comprising adding the contextual object attribute to the band of the user interface.

5. The method of claim 2, further comprising updating the contextual object attribute to the band of the user interface.

6. The method of claim 2, further comprising storing the contextual object attribute to the band of the user interface.

7. The method of claim 1, wherein searching comprises searching from a data source.

8. The method of claim 1, further comprising populating the contextual object attribute at runtime.

9. The method of claim 1, further comprising selecting a contextual object attribute based on a business application.

10. A system comprising:
a processor electronically coupled to a memory and a display means;
a search engine running on the processor to search for a contextual object attribute in a user interface;
a band contained within the user interface of the display to provide the contextual object attribute;
a selection module running on the processor to select the contextual object attribute from the band within the user interface to display; and
an electronic display means to display the contextual object attribute in the user interface.

11. The system of claim 10, further comprising an updater for updating the contextual object attribute to the band of the user interface.

12. The system of claim 10, further comprising an addition module for adding the contextual object attribute to the band of the user interface.

13. The system of claim 10, further comprising a memory electronically coupled to a processor, the memory for storing the contextual object attribute to the band of the user interface.

14. The system of claim 10, further comprising a data source electronically coupled to the search engine.

15. The system of claim 10, further comprising a selection device electronically coupled to provide for selection of the contextual object attribute.

16. An article of manufacture, comprising:
a machine readable medium having instructions for causing the machine to execute a method comprising:
searching for a contextual object attribute in a user interface;
providing the contextual object attribute in a band of the user interface;
selecting the contextual object attribute from the band to display; and
displaying the contextual object attribute in the user interface.

17. The machine-accessible medium of claim 16, further providing instructions which when executed by the machine, will cause the machine to perform further operations comprising invoking the band for displaying the contextual object attribute.

18. The machine-accessible medium of claim 16, further providing instructions which when executed by the machine, will cause the machine to perform further operations comprising selecting an invocation point from a group consisting of a browser menu, a toolbar, a drop down menu, an extension menu, a shortcut, a personalization service and a quick access.

19. The machine-accessible medium of claim 16, further providing instructions which when executed by the machine, will cause the machine to perform further operations comprising searching a data source.

20. The machine-accessible medium of claim 17, further providing instructions which when executed by the machine, will cause the machine to perform further operations comprising populating the contextual object attribute at runtime.
